(19) United States
(12) Patent Application Publication
(10) Pub. No.: US 2006/0072558 A1
(43) Pub. Date: Apr. 6, 2006

(54) Method and device for determining a system load of a processor system

(76) Inventors: Oliver Scheele, Moeglingen (DE); Michael Brunner, Crailsheim (DE)

Correspondence Address: KENYON & KENYON LLP, ONE BROADWAY, NEW YORK, NY, 10004, US

(21) Appl. No.: 11/238,510

(22) Filed: Sep. 28, 2005

(30) Foreign Application Priority Data
Sep. 28, 2004 (DE) 102004046878.8

(51) Int. Cl. H04L 12/50

(52) U.S. Cl. 370/360

(57) ABSTRACT

A method and a device for determining the system load of a processor system. The processor system transmits a process status via an interface, an active process status indicating that an active process is being executed. The active process status is transmitted to a protocol device. The protocol device records a first time interval, a first time interval corresponding to a time interval for which an active process status exists. The protocol device determines a system load existing within a monitoring period by relating the first time intervals which were recorded within this monitoring period to the duration of the monitoring period.

### BACKGROUND INFORMATION

Electronic control devices having a processor system are implemented in vehicles to execute software using this processor system. The system load of the processor system during the execution of the software is preferably determined at the time the control device and the software are developed.

German Patent No. DE 197 57 876 describes a method for determining the system load during the execution of a software program on the processor system. For this purpose, an idle program is called by the software when no functional processes need to be executed. The idle program increments an internal counter every time the idle program is called by the software. After the monitoring interval has been exceeded, the idle program determines the system load by relating the status of the internal counter to the monitoring interval. The idle program disadvantageously places a load on the processor system by incrementing the internal counter and determining the system load. In addition, this method does not allow the contribution of an individual process of a software program to the system load to be determined.

The operating system specification of OSEK (German abbreviation for Open systems and the corresponding interfaces for automotive electronics) does not prescribe that the execution of an idle program should be possible in the software of a control unit or that such a routine is to be provided. Therefore determining the system load based on such idle programs is to be avoided in order to be compatible with existing and future systems.

Another method uses special debugger tools for software packages, which are able graphically to display the execution and duration of the execution of an individual process. The system load can be determined manually from the graphic representation; however, this method is very complex and subject to errors.

### SUMMARY OF THE INVENTION

An object of the present invention is to provide a device and a method using which the system load of a processor system, caused by one or more processes executed on the processor system, may be determined, while avoiding the above-mentioned problems.

The object is achieved by the method and device according to the present invention.

One idea on which the present invention is based is that a processor system on which one or more active processes are executed transmits a process status to an interface. An active process status indicates that an active process is being executed. The active process status is transmitted to a protocol device. The protocol device records a first time interval, a first time interval corresponding to a time interval for which the active process status exists. The protocol device determines a system load existing within a monitoring period by relating the first time intervals which were recorded within this monitoring period to the duration of the monitoring period. This method advantageously places very little load on the processor system, because the processor system need only output the process status.

A device for determining the system load with the aid of the method according to the present invention has the protocol device having a memory device for storing the first time intervals, and a processor device for determining the system load based on the first time intervals. In this way no additional resources such as memory or a processor of the processor system are needed for determining the system load.

According to a preferred refinement, active processes are selected in one step, and the processor system indicates an active process status to the interface only for the selected active processes when such a selected active process is being executed by the processor system. Selecting an active process or multiple active processes makes determining their individual contribution to the overall system load possible.

According to another refinement of the method, the first time intervals of a monitoring period are added up for determining the system load.

According to another preferred refinement, active processes are selected in one step, and only the first time intervals of a monitoring period which belong to one of the selected processes are added up to determine the system load. This allows the individual contribution of one or more processes to the total system load to be determined without having to make any changes in the software being executed on the processor system.

According to another refinement, the process status is encoded by a binary information unit. This allows minimum processor system and interface resources to be used.

According to another preferred embodiment, the process status has a unique identifier of the corresponding active process, the unique identifier being recorded together with the first time interval. This simplifies the assignment of the first time intervals to the active processes for a subsequent analysis of the system load.

According to another refinement, a dedicated interface is provided for each of the active processes executed simultaneously.

According to another refinement, the protocol device has a dedicated timer.

According to another refinement, the device has an output device for displaying the system load using a graphic and/or text-based display.

According to another refinement, the device has a communication device for transmitting the process status to the protocol device.

### BRIEF DESCRIPTION OF THE DRAWINGS

FIG. 1 schematically shows an embodiment of the present invention.

FIG. 2 schematically shows a process sequence and a corresponding process status sequence of an embodiment.

FIG. 3 schematically shows a process status sequence, a selection sequence, and a corresponding process status sequence of an embodiment.

### DETAILED DESCRIPTION

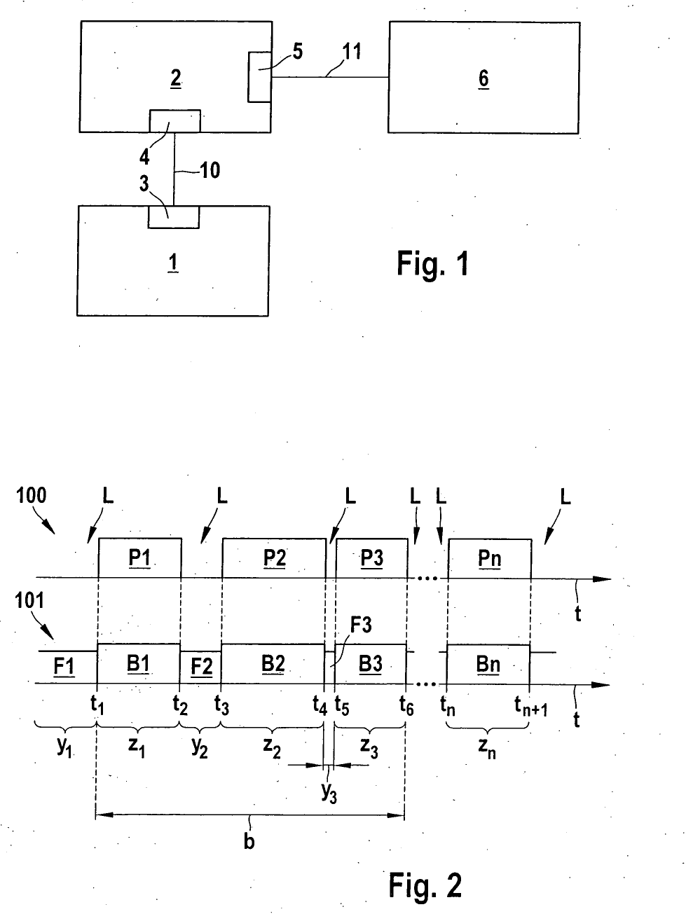

FIG. 1 shows one embodiment of the present invention. A processor system 1 has one or more processors. Processor system 1 is used to execute a software program which controls the operation of a vehicle, for example. The software program has individual active processes which are needed for the individual functions of the control system. These active processes may be executed consecutively or simultaneously. Processor system 1 may execute idle processes or wait loops between individual active processes. The idle processes or wait loops have no functionality. This is the case in particular in real-time systems which start the active processes at predefined points in time.

In the embodiment of the present invention, an active process status is output by processor system 1 via an interface 3 at the start of an active process. The output of the active process status by interface 3 is terminated when an active process is terminated. The process status may be encoded as a binary information unit, for example, as a bit, i.e., 0 level or 1 level at a terminal pin. The processor system of a protocol device 2 may thus transmit, using a minimum of resources, whether or not an active process is being executed in processor system 1.

The process status is transmitted by interface 3 to protocol device 2 via a communication device 10 and an interface 4 of protocol device 2. The protocol device records the process status. If an active process status exists, the protocol device records a first time interval, which specifies the duration of the active process status. For this purpose, the beginning and the end of the active process status, the beginning of the active process status and the duration of the active process status, or simply only the duration of the active process status may be stored as a first time interval, for example. Protocol device 2 has a memory device with volatile and/or non-volatile memory.

The system load of processor system 1 may be determined from the recorded time intervals. For this purpose, the first time intervals which were recorded within a predefined monitoring period are added up. A typical measure of the system load is the ratio of this sum to the duration of the monitoring period. A ratio of 1 indicates full utilization of the processor system. To monitor a processor system over an extended period, it is recommended to divide the time period into multiple monitoring periods having shorter durations. An individual monitoring period should be short enough to detect individual peak loads of processor system 1.

The time intervals and/or system loads detected are transmitted to an output device 6 via an output interface 5 and a communication device 11. This output device 6 permits a graphic display, for example, in the form of a plotter and/or a text-based display, for example, a list printout. Output device 6 may also be a computer system which allows for further analysis of the time intervals and/or the system loads.

Protocol device 2 has a processor device which makes it possible to determine the system load. Because the system load is determined in protocol device 2 and not in processor system 1, this embodiment of the present invention reduces the load on processor system 1. When the system load is being analyzed, processor system 1 advantageously behaves almost like a processor system 1 whose system load is not being analyzed. The method for determining the system load may thus also be used for monitoring daily operation of a processor system. In this case, the idea is in particular to monitor a control system of a vehicle during travel, because peak loads which might remain hidden in the lab may occur during travel.

A comparison of the utilization of different processor systems and/or software versions is made possible by the use of the same protocol device 2. The calculation of the system load may be adapted centrally in protocol device 2. No complex modification of the different processor systems and/or software versions is necessary for this purpose.

FIG. 2 schematically shows a process sequence and a corresponding process status sequence. A process sequence 100 has a plurality of individual active processes P1, P2, P3, Pn, which in this case are executed sequentially. Simultaneous execution of all or some of active processes P1, . . . , Pn is also possible. Processor system 1 executes no process between individual active processes P1, . . . , Pn. This non-execution is referred to as idle process L. In FIG. 2, an idle process L is indicated between each pair of consecutive active processes P1, . . . , Pn. This is shown as an example only. Two active processes 1, . . . , Pn may also directly follow each other. Process status sequence 101 plotted on time axis t provides process states F1, B1, F2, B2, B3, Bn, which are applied to interface 3. Thus, active process status B1 is being applied, for example, between points in time t1 and t2 during time interval z1, because in this time range active process P1 is being executed by processor system 1. Active process states P2, P3, and Pn are also being applied to interface 3 while active processes P2, P3, and Pn are being executed. An inactive process status F1, F2, F3 is applied to interface 3 during the execution of idle processes L. Protocol device 2 stores first time intervals z1, z2, z3 corresponding to active process states B1, . . . , Bn. To determine the system load during a suitably selected monitoring period b, first time intervals z1, z2, and z3 are related to the duration of monitoring period b. This is typically done by adding up time intervals z1, z2, z3, which have been registered within monitoring period b. For this purpose, these first time intervals z1, . . . , z3 may be added up and divided by the duration of the monitoring period. A second monitoring period b may immediately follow a first monitoring period b. As FIG. 2 shows, the beginning and the end of a monitoring period may coincide with the beginning and/or end of the execution of an active process. However, monitoring period b may also begin or end while an active process and/or an idle process is being executed. When the system load is determined, only a pro-rated portion of first time intervals z1, . . . , zn, which are not fully within monitoring period b, is to be included in the sum.

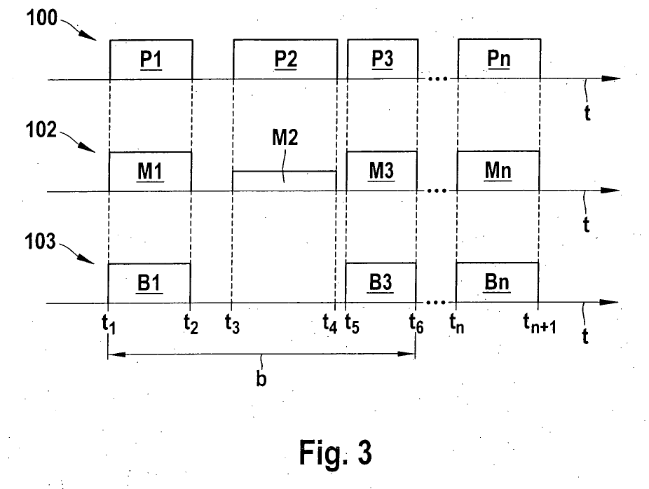

FIG. 3 schematically shows a process sequence 100, a mask sequence 102, and a process status sequence 103 according to another embodiment of the present invention. In the previous embodiment of FIG. 2, each active process P1, . . . , Pn contributes to the determined value of the system load. To determine the contribution of an individual active process P1, . . . , Pn or a portion thereof to the system load of processor system 1, an active process status B1, . . . , Bn is not output to interface 3 for each active process P1, . . . , Pn executed. In the embodiment of FIG. 3, no active process status is generated for interface 3 when active process P2 is being executed. When determining the system load within monitoring period b, only the contribution of active processes P1 and P3 is thus registered.

Another option for determining the contribution of an individual active process P1, . . . , Pn to the system load of processor system 1 is to implement a masking system in protocol device 2, which holds a mask value M1, . . . , Mn belonging to each active process P1, . . . , Pn. These mask values M1, . . . , Mn are assigned to the corresponding time intervals z1, . . . , zn of active processes P1, . . . , Pn by protocol device 2. When determining the system loads of processor system 1, only first time intervals z1, . . . , zn whose assigned mask values M1, . . . , Mn are set are taken into account. In the examples shown in FIG. 3, mask values M1, M3, and Mn are set, and mask value M2 is not set. Accordingly, when determining the system load in monitoring period b, only time intervals z1, . . . , zn of active process P1 and active process P3 are taken into account.

Mask values M1, . . . , Mn may be assigned to time intervals z1, . . . , zn by each process status B1, . . . , Bn having an identifier which uniquely assigns corresponding active process P1, . . . , Pn to this process status B1, . . . , Bn. By protocol device 2 recording this identifier together with time interval z1, . . . , zn, mask values M1, . . . , Mn may be uniquely assigned to time intervals z1, . . . , zn.

Although the present invention has been described above on the basis of a preferred exemplary embodiment, it is not limited thereto, but may be modified in multiple ways.

An active process status P1, . . . , Pn is not necessarily applied permanently to interface 3. It is also conceivable that a signal indicates the beginning of active process status B1, and a second signal signals the end of an active process status B1, . . . , Bn.

List of Reference Numerals

| | |
|---|---|
| 1 | processor system |
| 2 | protocol device |
| 3 | interface |
| 4 | interface |
| 5 | output interface |
| 6 | output device |
| 10, 11 | communication device |
| z1, z2, z3, zn | first time interval |
| t1-t6, tn, tn + 1 | points in time |
| 100 | process sequence |
| 101 | process status sequence |
| 102 | mask sequence |
| 103 | sequence of selected active process states |
| F1, F2, F3 | inactive process status |
| B1, B2, B3, Bn | active process status |
| P1, P2, P3, Pn | active processes |
| L | idle process |
| M1, M2, M3, Mn | mask |
| b | monitoring period |

What is claimed is:

1. A method for determining a system load of a processor system on which at least one active process is executed, the method comprising:
outputting a process status by the processor system to an interface, an active process status indicating that an active process is being executed;
transmitting the process status to an interface of a protocol device;
recording first time intervals by the protocol device, a first time interval corresponding to a time interval for which an active process status exists; and
determining the system load by the protocol device by relating the first time intervals which were recorded within a monitoring period to a duration of the monitoring period.

2. The method according to claim 1, wherein active processes are selected in one step, the active process status being output to the interface only for selected active processes.

3. The method according to claim 1, wherein the first time intervals of the monitoring period are added up for determining the system load.

4. The method according to claim 1, wherein active processes are selected in one step, and only the first time intervals of the monitoring period which belong to one of the selected processes are added up for determining the system load.

5. The method according to claim 1, further comprising encoding the process status by a binary information unit.

6. The method according to claim 1, wherein the process status has a unique identifier of a corresponding active process, and the unique identifier is recorded together with the first time interval.

7. The method according to claim 1, wherein a dedicated interface is provided for each of the at least one active process executed simultaneously.

8. A device for determining a system load of a processor system, the device comprising:
an interface for receiving transmitted process states from the processor system, an active process status indicating that an active process is being executed; and
a protocol device for recording first time intervals, a first time interval corresponding to a time interval for which an active process status exists, and for determining the system load by relating the first time intervals which have been recorded within a monitoring period to a duration of the monitoring period.

9. The device according to claim 8, wherein the protocol device includes a dedicated timer.

10. The device according to claim 8, further comprising an output device for displaying the system load as at least one of a graphic and a text-based display.

11. The device according to claim 8, further comprising a communication device for transmitting the process status to the protocol device.
